(19) United States
(12) Patent Application Publication
(10) Pub. No.: US 2009/0245063 A1
(43) Pub. Date: Oct. 1, 2009

(54) Device for Automatic Back-up, Organization and Operation using Voice Recognition Search Engine for Computer File Media

(76) Inventors: Horin Kobalo, Bat Yam (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/056,381

(22) Filed: Mar. 27, 2008

(51) Int. Cl. G11B 7/28; G10L 15/00

(52) U.S. Cl. 369/85; 704/246; 704/E15.001

(57) ABSTRACT

A digital memory organizer including a digital memory with a connection to a computer and designated software associated with the digital memory to carry out functions as automatic copying digital data, burning digital data onto hardware, organizing digital data according to the instruction of the user and in default of specific instruction, according to a default instruction. The designated software would also support voice recognition technology for the purpose of memory organization and memory retrieval.

### FIELD OF THE INVENTION

This invention is in the field of computers and in particular hardware for the operation of file back-up, file organization and an operating system for computer media.

### BACKGROUND OF THE INVENTION

In today's world of electronic data the quantities of stored data are vastly greater than they were a few years ago. All kinds of data are stored in digital form in digital memory, for example, text, pictures, video and music. There is a greater need today for organized storage of this vastness of information in an efficient manner and without wasting the user's time. Equally or even more important is the need for simplified and efficient retrieval of stored information. This invention reveals innovations in this field.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

This invention reveals a digital memory organizer including a digital memory with a connection to a computer and designated software associated with the digital memory to carry out at least one of the following list of functions, namely, copying digital data, burning digital data onto hardware, organizing digital data according to the instruction of the user and in default of specific instruction, according to a default instruction. The designated software would also support voice recognition technology for the purpose of memory organization and memory retrieval.

The connection between the organizer of this invention and the computer could be a terminal to terminal wired connection or a wireless connection.

The organizer would have designated software that would enable the organizer to perform a number of functions including a default feature that automatically copies the files on the computer hardware to the hard disc memory storage of the organizer, including CD discs, ipods, MP3/4 and other electronic media that are connected to and read by the computer.

The organizer could optionally have an integral screen in order to display digital content of the organizer.

The instruction to the organizer for the purpose of giving a name to a file or to retrieve a file could be vocal.

There could be software to convert data stored as vocal data into text data and to convert data stored as text data into vocal data.

The organizer could include an integral printer to print text or picture files from the memory.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a block chart showing a number of steps and variant features of this invention.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

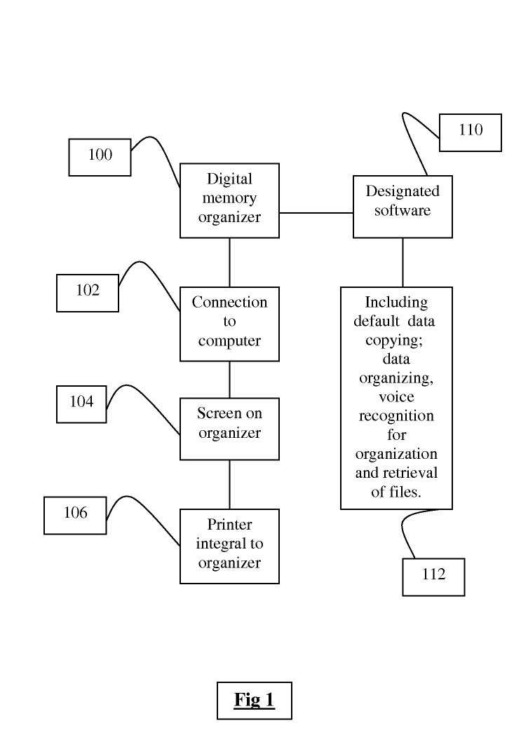

FIG. 1 shows a number of steps and variant features of this invention in block diagram format. The central device is independent and known as the digital memory organizer 100 with designated software 110 to carry out the various instructions and operate the various features of this invention. Some of these instructions and features 112 are to copy on a default basis, memory from the computer or CD's being read by the computer, organizing data in an orderly manner as the user instructs or according to a default instruction, allowing for vocal instruction for file organization and/or for retrieval of files from the memory. The organizer 100 is connected 102 by a wired connection or wirelessly to a computer.

Optionally the organizer 100 has an integral screen 104 and optionally an integral printer 106.

What is claimed:

1. A device for automatic burning, copying, digital memorizing and organizing digital files comprising:
a. A CD burning device
b. a digital memory hard disc
c. designated software associated with the said digital memory to carry out at least one of the following list of functions, namely, copying digital data, burning digital data onto hardware, organizing digital data according to the instruction of the user and in default of specific instruction, according to a default instruction, and
d. designated software to support voice recognition technology for the purpose of memory organization and memory retrieval.

2. A device as claimed in claim 1 wherein the device furthers includes connections to ipods, MP3/4 and other electronic media that are connected to and read by the computer.

3. A device as claimed in claim 1 wherein the device furthers includes a connection to a computer, wherein the said connection is a terminal to terminal wired connection.

4. A device as claimed in claim 1 wherein the device furthers includes a connection to a computer, wherein the said connection is a wireless connection.

5. A digital memory organizer as claimed in claim 1 wherein the said designated software includes a default feature that automatically copies the files on the said computer hardware to the hard disc memory storage of the said organizer.

6. A digital memory organizer as claimed in claim 1 further comprising a screen to display digital content.

7. A digital memory organizer as claimed in claim wherein the said instruction is vocal.

8. A digital memory organizer as claimed in claim 1 wherein the said file organization and retrieval is activated by vocal instruction.

9. A digital memory organizer as claimed in claim 1 further comprising software to convert data stored as vocal data into text data and to convert data stored as text data into vocal data.

10. A digital memory organizer as claimed in claim 1 further comprising a printer to print files from the said memory.
